(19) United States
(12) Patent Application Publication
(10) Pub. No.: US 2024/0217186 A1
(43) Pub. Date: Jul. 4, 2024

(54) RIB AND MANUFACTURING PROCESS THEREOF AND INFLATABLE PRODUCT

(71) Applicant: ZHEJIANG NATURAL OUTDOOR GOODS INC., Taizhou City (CN)

(72) Inventors: Yonghui Xia, Taizhou (CN); Mengzhi Zhou, Taizhou (CN); Zhijian Ma, Taizhou (CN)

(21) Appl. No.: 18/091,280

(22) Filed: Dec. 29, 2022

(51) Int. Cl. B29C 65/00; B29C 65/48

(52) U.S. Cl. CPC B29C 66/0326; B29C 65/48; B29L 2022/02

(57) ABSTRACT

A rib, a manufacturing process thereof and an inflatable product are provided, wherein the manufacturing process of the rib includes the following steps: forming an annular region and an enclosed region by weaving according to a preset size, performing a local gluing on both sides of the surface of the annular region respectively; cutting at the enclosed region so as to form a closed-loop rib, wherein the annular region is formed by using a direction of weaving, the enclosed region is formed on both sides of the annular region through the weaving points, and gluing layers are formed by means of performing a local gluing in the annular region, finally, it is only required to cutting the enclosed region to form the closed-loop rib, such that a direct forming of the weaving to the rib is realized, and the local gluing can also be performed on surfaces of the rib.

### TECHNICAL FIELD

The present disclosure relates to the technical field of inflatable products, and more particularly, to a rib and a manufacturing process thereof and an inflatable product.

### BACKGROUND ART

The so-called inflatable product refers to: a product with a specific shape which is formed by firstly providing an inflatable cavity enclosed by a plurality of peripheral pieces, and then inflating the inflatable cavity. The inflatable products have been widely used for their advantages of being comfortable, easy to carry and soft. The inflatable products include a plurality of products such as inflatable beds, inflatable sofas, inflatable toys and inflatable castles, etc. Among those inflatable products, the peripheral pieces of most of them are usually made of soft materials; therefore, the inflatable products will form a sphere, such as a balloon, during inflation.

In the prior art, in order to avoid the inflatable product becoming a sphere after inflation, people usually arrange ribs inside the inflatable cavity, the ribs are connected with the peripheral pieces and are capable of serving as supporting and shaping. Therefore, the inflatable product can form a specific shape according to the positions of the ribs being arranged inside the inflatable cavity, the number of the ribs and the enclosing shape of the peripheral pieces.

However, in order to make inflatable products comfortable, stable and durable, many ribs are usually added to the interior of the products. The existing manufacturing process for the ribs is to apply a complete gluing on the fabric (that is, the surface is covered with TPU/PVC film completely), and then the ribs are manufactured. However, the price of gluing for either Thermoplastic polyurethanes (TPU) or Polyvinyl chloride (PVC) is high and the weight thereof is large. Therefore, applying complete gluing will invisibly increase the cost and weight of inflatable products. In addition, the manufacturing of the ribs in the prior art requires cutting the fabric and then performing secondary processing to make the fabric into cylinder, resulting in the technical problems of a complicated process and a long time-consuming.

### SUMMARY

The object of the present disclosure is to provide a rib (reinforcement rib) and a manufacturing process thereof and an inflatable product, so as to alleviate the existing technical problems in the prior art, which are the increasing cost and weight of the inflatable product caused by complete gluing to the surfaces of ribs, and the complicated process and long time-consuming for the manufacture of the ribs.

A rib manufacturing technique provided by the present disclosure includes the following steps:
forming an annular region and an enclosed region by weaving according to a preset size, wherein the enclosed region is formed as weaving points on both sides of the annular region;
forming a gluing layer along both sides of a surface of the annular region, and performing a local gluing on both sides of the surface of the annular region respectively; and
cutting the enclosed region after gluing is completed, so as to form a closed-loop rib.

In a preferred embodiment of the present disclosure, the step of forming the annular region and the enclosed region by weaving according to the preset size further includes:
obtaining a plurality of weaving points by weaving along a first direction correspondingly according to a size of the closed-loop rib, so as to form a plurality of annular regions and enclosed regions arranged at intervals in sequence.

In a preferred embodiment of the present disclosure, interval widths of a plurality of the enclosed regions along the first direction are the same, and an interval width range for each of the enclosed regions is greater or equal to 3 cm.

In a preferred embodiment of the present disclosure, each of the annular regions includes an upper sheet of fabric and a lower sheet of fabric, two ends of the upper sheet of fabric along the first direction and two ends of the lower sheet of fabric along the first direction are formed as weaving points, so as to extend weaving and form the enclosed regions; and
a sum of gate sizes of the upper sheet of fabric and the lower sheet of fabric of the annular regions is equal to a cross-sectional perimeter of the closed-loop rib.

In a preferred embodiment of the present disclosure, the step of obtaining a plurality of the weaving points by weaving along the first direction includes:
based on a plurality of size requirements of the closed-loop rib, obtaining weaving points with different distances by weaving along the first direction correspondingly, such that widths of a plurality of the annular regions along the first direction are different.

In a preferred embodiment of the present disclosure, the step of performing the local gluing on both sides of the surface of the annular region respectively further includes:
Performing the local gluing on a surface of a side along the upper sheet of fabric away from the lower sheet of fabric and a surface on a side along the lower sheet of fabric away from the upper sheet of fabric at the same time, wherein
gluing points of the local gluing are distributed at intervals along a second direction, and the gluing points on the upper sheet of fabric and the lower sheet of fabric are symmetrically arranged,
wherein the first direction and the second direction are two directions perpendicular to each other along the surface.

In a preferred embodiment of the present disclosure, the local gluing includes local point gluing or local flow casting.

In a preferred embodiment of the present disclosure, the step of cutting the enclosed region further includes:
cutting a plurality of the closed regions in sequence along the first direction after the gluing is completed, so as to form a plurality of the annular regions; and
cutting a plurality of the annular regions along the second direction, so as to form the closed-loop ribs with corresponding sizes.

A rib provided by the present disclosure is obtained by manufacturing through the rib manufacturing process.

An inflatable product provided by the present disclosure includes a cover cloth, a base cloth and the rib;
the rib is located between the cover cloth and the base cloth, gluing layers are provided at intervals along surfaces of both sides of the rib, and the rib is connected with the cover cloth and the base cloth through gluing layers on both sides by a hot melting process respectively; and

The rib is provided as plural, and a plurality of the ribs are arranged at intervals along an extension direction perpendicular to the ribs.

The rib manufacturing process provided by the present disclosure includes the following steps: weaving according to a preset size to form an annular region and an enclosed region, wherein the enclosed region is formed as weaving points on both sides of the annular region; forming a gluing layer along both sides of a surface of the annular region, and perform a local gluing on both sides of the surface of the annular region respectively; cutting at the enclosed region after gluing is completed, so as to form a closed-loop rib, wherein the annular region is formed by using a direction of the weaving, and the enclosed region is formed by weaving points on both sides of the annular region, meanwhile the gluing layer is formed by means of local gluing in the annular region, finally, it is only required to cut the enclosed region to form the closed-loop rib, so as to realize a direct forming of the weaving to the rib, and the local gluing performed on surfaces of the rib can also be realized, which saves the cost, reduces the weight, ensures the waste of the material, and alleviates the existing technical problems in the prior art, such as the increasing of cost and weight of the inflatable product caused by complete gluing on the surfaces of the ribs, and the complicated process and long time-consuming for manufacturing the ribs.

### BRIEF DESCRIPTION OF DRAWINGS

In order to more clearly explain the technical solution in the embodiments of the present disclosure, the following content will be used to briefly introduce the drawings illustrated in the embodiments, it is obviously that the following drawings only illustrate some embodiments of the present disclosure, for ordinary people skilled in this filed, other relevant drawings according to these drawings without paying for any creative work can be obtained.

FIG. 1 shows an overall schematic structural diagram formed during a weaving process of a rib manufacturing process provided by an embodiment of the present disclosure;

FIG. 2 shows a front structural diagram formed during the weaving process of the rib manufacturing process provided by the embodiment of FIG. 1;

FIG. 3 shows a schematic structural diagram of a closed-loop rib after cutting and forming in the rib manufacturing process provided by an embodiment of the present disclosure;

FIG. 4 shows a schematic diagram of an explosive structure in which the rib is located inside an inflatable product provided by an embodiment of the present disclosure;

FIG. 5 shows a schematic diagram of an explosive structure in which the rib is located inside another inflatable product provided by an embodiment of the present disclosure; and

FIG. 6 shows a schematic structural diagram of the inflatable product provided by an embodiment of the present disclosure.

Labeling: 100—annular region; 101—upper sheet of fabric; 102—lower sheet of fabric; 200—enclosed region; 300—gluing layer; 400—cover cloth; 500—base cloth.

### DETAILED DESCRIPTION OF EMBODIMENTS

The following will clearly and completely describe the technical solutions of the present disclosure in combination with the embodiments. Obviously, the described embodiments are part of the embodiments of the present disclosure, not all of the embodiments. Based on the embodiments in the present disclosure, all other embodiments obtained by ordinary people skilled in this field without paying for creative work belong to the scope of protection of the present disclosure.

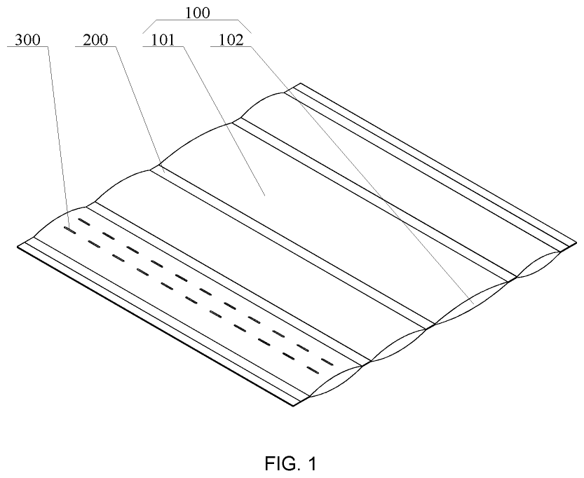

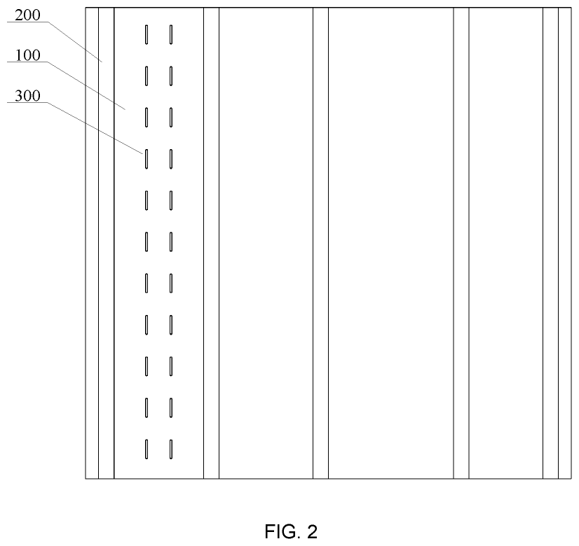

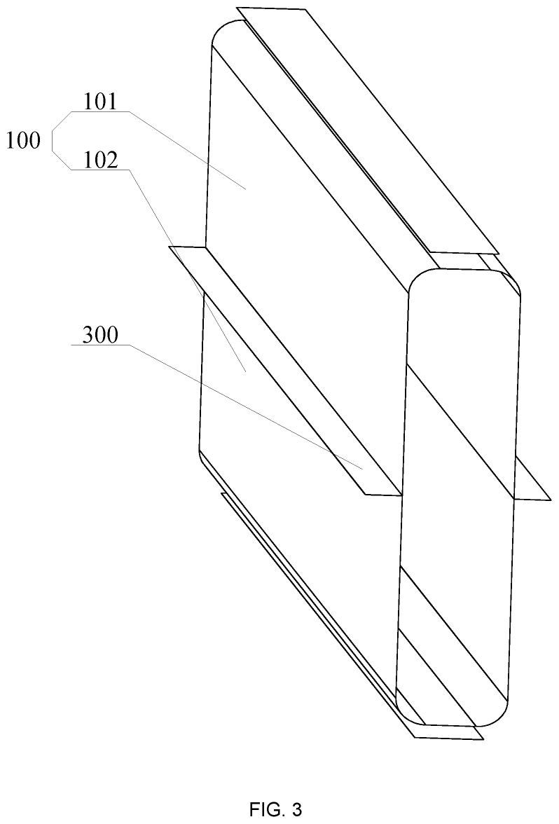

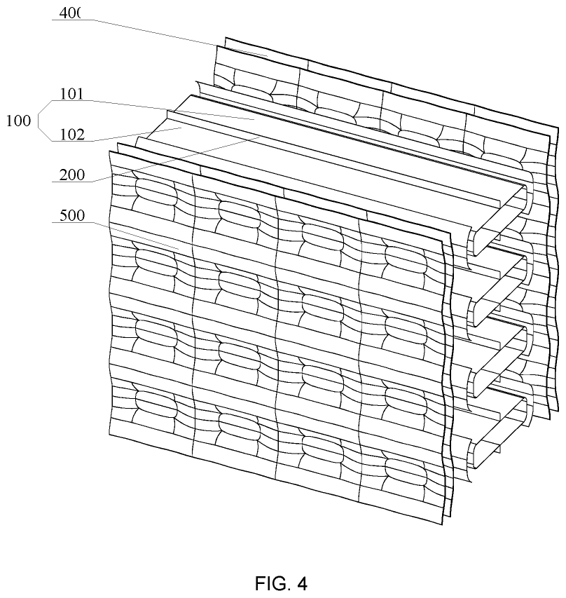

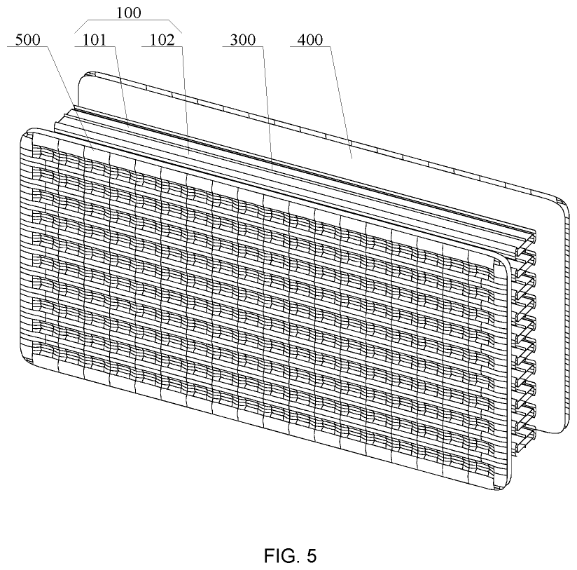

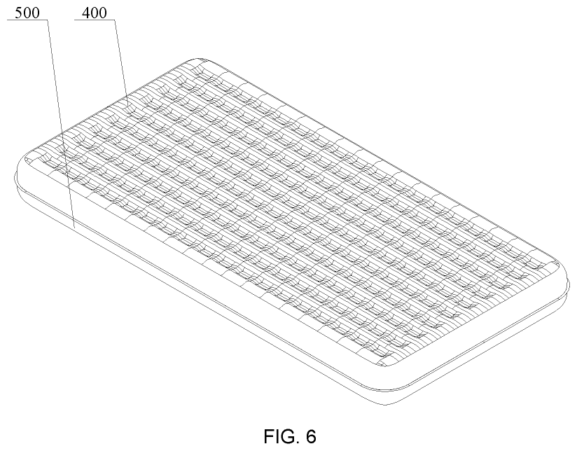

As shown in FIG. 1-FIG. 6, a rib manufacturing process provided by the present embodiment includes the following steps: forming an annular region 100 and an enclosed region 200 by weaving according to a preset size, wherein the enclosed region 200 is formed as weaving points on both sides of the annular region; forming a gluing layer along both sides of a surface of the annular region 100, and performing a local gluing on both sides of the surface of the annular region respectively; and performing a cutting on the enclosed region after gluing is completed, so as to form a closed-loop rib.

It should be noted that, the rib manufacturing process provided by the present embodiment can adopt a new weaving process and a local gluing process, which can save cost and weight and eliminate material waste on the basis of realizing the manufacture of the rib. Specifically, the annular region 100 and the enclosed region 200 are formed by the way of weaving according to the size of the product used with the rib, wherein the woven fabric of raw cloth can be made of cotton cloth, polyester cloth or nylon cloth, etc., in the weaving stage, weaving points with different distances are correspondingly woven according to a required size of the product, so as to form the annular region 100 of the main body of the rib, and form the enclosed region 200 on both sides of the annular region 100. Further, by the way of performing a local gluing on the opposite sides of the surface of the annular region 100 respectively, a glue dispensing can be performed at intervals along the extension direction of the annular region 100. After the gluing is completed, by cutting the enclosed region 200, that is, cutting out an individual annular region 100 to form the closed-loop draw, when the rib needs to be installed in an inflatable product, it is only required to use the position of the glue to perform the connection.

Optionally, the way of weaving to form the annular 100 and the enclosed region 200 can be adopted in such a way that the weft yarns are arranged in parallel, and the warp yarns are woven and formed with the weft yarns by the way of bending in a V-shape in sequence. Wherein, the weaving edge formed by weaving can be formed by rotating the weft yarns around the external warp yarns and returning them back toward the other side, the weaving edge has wear resistance, because the weft yarns which are bent back lock the external warp yarns.

The rib manufacturing process provided by the present embodiment includes the following steps: forming the annular region 100 and the enclosed region 200 by weaving according to the preset size, wherein the enclosed region 200 is formed as weaving points on both sides of the annular region; forming a gluing layer along both sides of a surface of the annular region, and performing a local gluing on both sides of the surface of the annular region respectively; and performing a cutting on the enclosed region 200 after gluing is completed, so as to form a closed-loop rib, wherein the annular region 100 is formed by using the direction of weaving, and the enclosed region 200 is formed through the weaving points on both sides of the annular region 100, meanwhile the gluing layer 300 is formed by the way of performing the local gluing to the annular region 100, finally, it is only required to perform a cutting on the enclosed region 200 to form the closed-loop rib is formed by performing cutting to, so as to realize a direct forming of the weaving to the rib, and the local gluing being performed on surfaces of the rib can also be realized, which saves the cost, reduces the weight, ensures the waste of the material, and alleviates the existing technical problems in the prior art, which are the increasing of cost and weight of the inflatable product caused by a complete gluing on the surfaces of the ribs, and the complicated process and long time-consuming for manufacturing the ribs.

On the basis of the above embodiment, further, in a preferred embodiment of the present disclosure, the step of forming the annular region 100 and the enclosed region 200 by weaving according to the preset size further includes: weaving, according to the size of the closed-loop rib, a plurality of weaving points correspondingly along a first direction, so as to form a plurality of annular regions 100 and enclosed regions 200 arranged in sequence at intervals.

In the present embodiment, in the weaving process, it can be woven in sequence and in one direction which is in the horizontal direction, when a plurality of the weaving points are woven correspondingly along the first direction, that is, a plurality of the enclosed regions 200 can be woven at intervals along the first direction, one annular region 100 is clamped between any two adjacent enclosed regions 200, that is, it is ensured that both sides of each of the annular regions 100 can be sealed by the enclosed regions 200 formed by the weaving points, and a plurality of the annular regions 100 are formed synchronously through one fabric of raw cloth formed by weaving, that is, a plurality of the closed-loop ribs can be obtained respectively, after any two adjacent closed regions 200 are performed with cutting.

In a preferred embodiment of the present disclosure, the interval widths of a plurality of the enclosed regions 200 along the first direction are the same, and the interval width range of each of the enclosed regions 200 is greater than or equal to 3 cm.

In the present embodiment, it is more convenient to ensure the specs of each of the annular regions 100 by weaving and forming a plurality of the enclosed regions 200 with equal width intervals, that is, a cutting at the central position of the enclosed region 200 can be performed better, therefore, so that the extended lengths of the two ends of sealing of each of the annular regions 100 are the same. Preferably, the interval width of each of the enclosed regions 200 is greater than or equal to three millimeters.

It should be noted that, after a plurality of the annular regions 100 and the enclosed regions 200 are formed by weaving, it is required to leave a safety distance at each of both ends of breadth of the fabric, that is, the width of the two ends of the breadth of the fabric formed by weaving is a sum of the width of a single enclosed region 200 and the safety distance.

In a preferred embodiment of the present disclosure, the annular region 100 includes an upper sheet of fabric 101 and a lower sheet of fabric 102, two ends of the upper sheet of fabric 101 along the first direction and two ends of the lower sheet of fabric 102 along the first direction are the weaving points, such that the weaving is extended to form the enclosed regions 200; and a sum of gate sizes of the upper sheet of fabric 101 and the lower sheet of fabric 102 of the annular regions 100 is equal to a cross-sectional perimeter of the closed-loop rib.

In the present embodiment, the annular region 100 is formed by overlapping the upper sheet of fabric 101 and the lower sheet of fabric 102, that is, the enclosed region 200 is formed by the way of weaving the upper sheet of fabric 101 and the lower sheet of fabric 102 with a preset width, that is, the annular region 100 can be formed between the upper sheet of fabric 101 and the lower sheet of fabric 102 when it is between two enclosed regions 200. After the enclosed region 200 is cut, the upper sheet of fabric 101 and the lower sheet of fabric 102 are extended along a direction perpendicular to the first direction, respectively, that is, an O-shaped structure of the rib can be formed by extending. Further, in order to ensure the specs of the O-shaped rib, it is ensured that the sum of the gate sizes of the upper sheet of fabric 101 and the lower sheet of fabric 102 of the annular region 100 is equal to the cross-sectional perimeter of the closed-loop rib, thus the size specs of the formed O-shaped rib is further determined.

In a preferred embodiment of the present disclosure, the step of weaving a plurality of weaving points correspondingly along the first direction further includes: based on a plurality of size requirements of the closed-loop rib, obtaining weaving points with different distances by weaving correspondingly along the first direction, such that widths of a plurality of the annular regions 100 along the first direction are different.

In the present embodiment, when ribs with a plurality of specs and sizes are formed by one fabric of raw cloth simultaneously, the width of each of the annular regions 100 in the first direction can be different during the weaving process, that is, the sum of sizes of breadth formed by the upper sheet of fabric 101 and the lower sheet of fabric 102 of each of the annular regions 100 is exactly the same as the cross-sectional perimeter of the closed-loop rib with the size specs as required, so that it is realized that a plurality of specs and sizes of ribs are formed by a simultaneous weaving at one time. In addition, when the annular regions and the enclosed regions are arranged at intervals, the widths of the annular regions 100 along the first direction can be different, and the widths of the enclosed regions 200 along the first direction are the same, therefore, convenience in cutting process can be ensured.

In a preferred embodiment of the present disclosure, the step of performing the local gluing on both sides of the surface of the annular region 100 respectively further includes: performing the local gluing on a surface of a side along the upper sheet of fabric 101 away from the lower sheet of fabric 102, and a surface of a side along the lower sheet of fabric 102 away from the upper sheet of fabric 101 at the same time, wherein the gluing points of the local gluing are distributed at intervals along a second direction, and the gluing points on the upper sheet of fabric 101 and the lower sheet of fabric 102 are symmetrically arranged, and wherein the first direction and the second direction are two directions perpendicular to each other along the surface.

In the present embodiment, the upper surface of the upper sheet of fabric 101 and the lower surface of the lower sheet of fabric 102 are performed with local gluing at the same time, the gluing points can be orderly distributed, the shapes can be regular shapes or made according to the molds, and the gluing widths can be different, that is, the structures and shapes for the gluing points can both be set in a way convenient for operations. When the gluing points of the upper sheet of fabric 101 and the lower sheet of fabric 102 are required to be ensured to be symmetrically arranged in the present embodiment, that is, after the closed-loop rib is formed through the enclosed region 200 between the upper sheet of fabric 101 and the lower sheet of fabric 102, at this time, the upper sheet of fabric 101 and the lower sheet of fabric 102 are required to be performed with a hot-press connection through the inflatable product and the corresponding gluing points, respectively, and it can be ensured that the connecting stress points on both sides of the rib are consistent through the symmetrical arrangement of the gluing points on opposite sides of the rib, so as to better ensure the stability of the inflatable product after its formation, and improve the stability and service life of the connection of the inflatable product.

It should be noted that, the first direction and the second direction are two coordinate axes perpendicular to each other in a horizontal two-dimensional coordinate system.

In a preferred embodiment of the present disclosure, local gluing includes local point gluing or local flow casting.

In the present embodiment, the local gluing can be performed with local point gluing by means of molds at the same time, or it can be symmetrically arranged on two opposite sides respectively by means of mold flow casting.

Optionally, there are also a plurality of options for adhesive materials for local gluing. For example: TPE (Thermoplastic Elastomer), TPU (Thermoplastic polyurethanes), TPR (Thermo-Plastic-Rubber material), TPV (Thermoplastic Vulcanizate), PVC (Polyvinyl chloride), TPO (Thermoplastic polyolefin), TPVC, TPVE (phenyl vinyl ether) and EVA (Ethylene Vinyl Acetate), etc., preferably, the local gluing can be TPU or PVC local gluing.

In a preferred embodiment of the present disclosure, the step of cutting at the enclosed region 200 further includes: performing a cutting, after the gluing is completed, on a plurality of the enclosed regions 200 in sequence along the first direction, so as to form a plurality of the annular regions 100; and performing a cutting, along the second direction, on a plurality of the annular regions 100 formed by cutting, so as to form the closed-loop ribs with corresponding sizes.

Take an example to illustrate, the first enclosed region 200, the first annular region 100, the second enclosed region 200, the second annular region 100 and the third enclosed region 200, etc., are extended and arranged at intervals along the first direction, wherein, what is necessary to be ensured is that the two ends of the first direction are the enclosed region 200, respectively, that is, the number of the enclosed regions 200 is one larger than that of the annular regions 100. Further, after the enclosed region 200 is completed with cutting, the annular region 100 is performed with cutting in the second direction for the selection of the inflatable product at this time, that is, the manufacturing of the ribs with different lengths requirements is completed.

A rib provided by the present embodiment can be obtained by manufacturing with the rib manufacturing process. Since the technical effect of the rib provided by the present embodiment is the same as that of the rib manufacturing process provided by the above embodiments, it is not repeated herein.

An inflatable product provided by the present embodiment includes: a cover cloth 400, a base cloth 500 and the rib; the rib is located at a position between the cover cloth 400 and the base cloth 500, gluing layers 300 are provided at intervals along the surfaces of both sides of the rib, and the rib is connected with the cover cloth 400 and the base cloth 500 respectively through the gluing layer 300 on both sides by a hot melting process; the rib is provided as plural, and a plurality of the ribs are provided at intervals along an extension direction perpendicular to the ribs.

Optionally, since the rib mainly serves to support and shape, in order to make the inflatable product provided by the present embodiment have a more stable shape that is not easily deformed, a plurality of the ribs can be arranged at intervals between the cover cloth 400 and the base cloth 500.

In the present embodiment, the ribs are applied to an inflatable mattress, wherein both the cover cloth 400 and the base cloth 500 can adopt TPU coated sheet of fabric, a wear resistance is achieved and it is good for environmental protection and suitable for a variety of outdoor environments. A plurality of the O-shaped ribs with a long strip structure manufactured by the above process are provided between the cover cloth 400 and the base cloth 500, by an arrangement at intervals with uniform space, two opposite sides of the ribs are performed with a hot melting connection with the cover cloth 400 and the base cloth 500 through the positions of the local gluing, respectively, so that a plurality of patterns are formed on the surface of the inflatable mattress, which also act as a pillar at the same time. The technical effects of rapid charging and discharging and convenient to carry are realized by providing an air valve on the inflatable mattress. Faster manufacturing of the ribs is realized through performing practical applications of the ribs formed by manufacturing with the rib manufacturing process provided by the above embodiments, it reduces the manual alignment process in the entire manufacturing process of inflatable products and improves the manufacturing efficiency.

Finally, it should be stated that the above embodiments are only used to illustrate the technical solutions of the present disclosure, not to restrict it; although the present disclosure is described in detail with reference to the aforementioned embodiments, those ordinary skilled in the art should understand that they can still modify the technical solution recited in the aforementioned embodiments, or replace some or all of the technical features with equivalents; these modifications or replacements do not make the essence of the corresponding technical solutions out of the scope of the technical solutions of embodiments of the present disclosure.

What is claimed is:

1. A rib manufacturing process, comprising steps of:
weaving according to a preset size to form an annular region and an enclosed region, wherein the enclosed region is formed as weaving points on both sides of the annular region;
forming a gluing region along both sides of a surface of the annular region, and performing a local gluing on both sides of the surface of the annular region respectively; and
cutting at the enclosed region after the gluing is completed, so as to form a closed-loop rib.

2. The rib manufacturing process according to claim 1, wherein the step of weaving according to the preset size to form the annular region and the enclosed region further comprises:
obtaining a plurality of weaving points by weaving, according to a size of the closed-loop rib, correspondingly along a first direction, so as to form a plurality of annular regions and enclosed regions arranged at intervals in sequence.

3. The rib manufacturing process according to claim 2, wherein interval widths of a plurality of the enclosed regions along the first direction are the same.

4. The rib manufacturing process according to claim 3, wherein each of the annular regions comprises an upper sheet of fabric and a lower sheet of fabric, two ends of the upper sheet of fabric along the first direction and two ends of the lower sheet of fabric along the first direction are taken as weaving points, so as to extend the weaving and form the enclosed regions; and
a sum of breadth sizes of the upper sheet of fabric and the lower sheet of fabric of the annular region is equal to a cross-sectional perimeter of the closed-loop rib.

5. The rib manufacturing process according to claim 4, wherein the step of obtaining a plurality of the weaving points by weaving correspondingly along the first direction further comprises:
obtaining weaving points with different distances by weaving, based on a plurality of size requirements of the closed-loop rib, correspondingly along the first direction, such that widths of a plurality of the annular regions along the first direction are different.

6. The rib manufacturing process according to claim 4, wherein the step of performing the local gluing on both sides of the surface of the annular region respectively further comprises:
performing a local gluing on a surface of a side along the upper sheet of fabric away from the lower sheet of fabric and a surface of a side along the lower sheet of fabric away from the upper sheet of fabric simultaneously,
wherein gluing points of the local gluing are distributed at intervals along a second direction, and gluing points on the upper sheet of fabric and the lower sheet of fabric are arranged symmetrically, and
wherein the first direction and the second direction are two directions perpendicular to each other along the surface.

7. The rib manufacturing process according to claim 6, wherein the local gluing comprises local point gluing or local flow casting.

8. The rib manufacturing process according to claim 2, wherein the step of cutting at the enclosed region further comprises:
cutting, along the first direction, a plurality of the enclosed regions in sequence after the gluing is completed, so as to form a plurality of the annular regions; and
cutting, along the second direction, a plurality of the annular regions formed by cutting, so as to form the closed-loop rib with a corresponding size.

9. A rib, wherein the rib is obtained through the rib manufacturing process according to claim 1.

10. An inflatable product, comprising a cover cloth, a base cloth and the rib according to claim 9,
wherein the rib is located at a position between the cover cloth and the base cloth, gluing layers 300 are provided at intervals along surfaces of both sides of the rib, and the rib is connected with the cover cloth and the base cloth through the gluing layers on both sides by a hot melting process respectively; and
plural ribs are provided, and the plural ribs are arranged at intervals along an extension direction perpendicular to the ribs.

11. The rib manufacturing process according to claim 3, wherein the step of cutting at the enclosed region further comprises:
cutting, along the first direction, a plurality of the enclosed regions in sequence after the gluing is completed, so as to form a plurality of the annular regions; and
cutting, along the second direction, a plurality of the annular regions formed by cutting, so as to form the closed-loop rib with a corresponding size.

12. The rib manufacturing process according to claim 4, wherein the step of cutting at the enclosed region further comprises:
cutting, along the first direction, a plurality of the enclosed regions in sequence after the gluing is completed, so as to form a plurality of the annular regions; and
cutting, along the second direction, a plurality of the annular regions formed by cutting, so as to form the closed-loop rib with a corresponding size.

13. The rib manufacturing process according to claim 5, wherein the step of cutting at the enclosed region further comprises:
cutting, along the first direction, a plurality of the enclosed regions in sequence after the gluing is completed, so as to form a plurality of the annular regions; and
cutting, along the second direction, a plurality of the annular regions formed by cutting, so as to form the closed-loop rib with a corresponding size.

14. The rib manufacturing process according to claim 6, wherein the step of cutting at the enclosed region further comprises:
cutting, along the first direction, a plurality of the enclosed regions in sequence after the gluing is completed, so as to form a plurality of the annular regions; and
cutting, along the second direction, a plurality of the annular regions formed by cutting, so as to form the closed-loop rib with a corresponding size.

15. The rib manufacturing process according to claim 7, wherein the step of cutting at the enclosed region further comprises:
cutting, along the first direction, a plurality of the enclosed regions in sequence after the gluing is completed, so as to form a plurality of the annular regions; and
cutting, along the second direction, a plurality of the annular regions formed by cutting, so as to form the closed-loop rib with a corresponding size.

16. The rib according to claim 9, wherein the step of weaving according to the preset size to form the annular region and the enclosed region further comprises:
obtaining a plurality of weaving points by weaving, according to a size of the closed-loop rib, correspondingly along a first direction, so as to form a plurality of annular regions and enclosed regions arranged at intervals in sequence.

17. The rib according to claim 16, wherein interval widths of a plurality of the enclosed regions along the first direction are the same.

18. The rib according to claim 17, wherein each of the annular regions comprises an upper sheet of fabric and a lower sheet of fabric, two ends of the upper sheet of fabric along the first direction and two ends of the lower sheet of fabric along the first direction are taken as weaving points, so as to extend the weaving and form the enclosed regions; and
a sum of breadth sizes of the upper sheet of fabric and the lower sheet of fabric of the annular region is equal to a cross-sectional perimeter of the closed-loop rib.

19. The rib according to claim 18, wherein the step of obtaining a plurality of the weaving points by weaving correspondingly along the first direction further comprises:
obtaining weaving points with different distances by weaving, based on a plurality of size requirements of the closed-loop rib, correspondingly along the first direction, such that widths of a plurality of the annular regions along the first direction are different.

20. The rib according to claim 18, wherein the step of performing the local gluing on both sides of the surface of the annular region respectively further comprises:
performing a local gluing on a surface of a side along the upper sheet of fabric away from the lower sheet of fabric and a surface of a side along the lower sheet of fabric away from the upper sheet of fabric simultaneously,
wherein gluing points of the local gluing are distributed at intervals along a second direction, and gluing points on the upper sheet of fabric and the lower sheet of fabric are arranged symmetrically, and
wherein the first direction and the second direction are two directions perpendicular to each other along the surface.
